(19) United States
(12) Patent Application Publication
(10) Pub. No.: US 2006/0270956 A1
(43) Pub. Date: Nov. 30, 2006

(54) Opto-mechatronic acupressure pen

(75) Inventors: Thomas K. S. Wong, Kowloon (HK); Joanne W. Y. Chung, Kowloon (HK); K. L. Fan, Kowloon (HK); Max W. L. Chow, Kowloon (HK)

Correspondence Address: NORRIS, MCLAUGHLIN & MARCUS, P.A., 875 THIRD AVE, 18TH FLOOR, NEW YORK, NY, 10022, US

(73) Assignee: The Hong Kong Polytechnic University, Kowloon (HK)

(21) Appl. No.: 11/135,960

(22) Filed: May 24, 2005

(51) Int. Cl. A61H 23/00

(52) U.S. Cl. 601/108; 606/238; 606/204

(57) ABSTRACT

An acupuncture pen comprises: a casing (11); a blunt tip (13), provided at the front end of the casing moveably; a sensing unit (12), provided in the casing (11) for detecting the movement of the tip (13); An A/D converter (15), provided in the casing (11) for converting the analog signal from the sensing unit (12) into digital signal; a microcontroller (16), provided in the casing (11) for receiving the digital signal from the A/D converter (15), and calculating the force blunt tip (13) applied on the skin on the basis of the received digital signal; and a digital display, provided in the wall of the casing, and electrically connected with the microcontroller (16) for indicating the calculated force. With such structure, the acupuncture pen of this invention can achieve compact configuration and indicate the force applied by the pen visually.

### TECHNICAL FIELD

This invention relates to a medical appliance, more specifically, to an opto-mechatronic acupressure pen capable of achieving non-intrusive stimulation for therapeutic treatments without piecing the skin.

### BACKGROUND OF THE ART

Acupuncture points have been well known in China from earliest times and most of them are held to correspond to specific organs and area of the body. Acupuncturists work by inserting needles of varying lengths at these points. When particular acupuncture points are stimulated, the corresponding areas being treated respond to the stimulation. Each acupuncture point occupies only a very small area, approximately half of a square millimeter on the skin surface. An acupuncture point is highly sensitive and the feeling elicited in respond to pressure is quite different from the surrounding tissues. The acupuncturist will, of course, insert his or her needle in such points but non-invasively pressing on the point can be almost as effective. After application of a therapeutic quantity of pressure to a particular acupuncture point of patients that suffer from a wide range of illnesses, including asthma, low-back pain, fatigue, weight reduction and so on, the length of time for which relief lasts will vary from patient to patient from a few minutes to several hours, or even days, but the effectiveness of the point will not diminish through use and the same result will be obtained time and time again.

Thus, it has become important to be able to deliver an accurately known pressure to a particular point upon the skin of the body in order to effect relief of pain and other symptoms.

U.S. Pat. No. 5,224,264 discloses a device for applying a therapeutic amount of pressure to the skin and underlying tissue. This device includes a pressure sensor for measuring the pressure on the patient's skin and underlying tissue. A digital controller monitors the pressure exerted on the skin and the elapsed time period during which the skin has been exposed to the measured pressure. When the pressure reaches a preset level, a timer starts. When the combination of pressure and elapsed time reaches a previously determined level, this is indicated by a digital readout device which converting the electrical signal into a visual display of the magnitude of the applied pressure.

The acupressure device mentioned in U.S. Pat. No. 5,224,264 uses force sensor to detect the applied force. However, the product that utilizes force sensors may be expensive and hazardous. On the other hand, the readout device of the acupressure device mentioned in U.S. Pat. No. 5,224,264 is separated from the acupressure pen and connected to the acupressure pen by means of electrical wires. This makes the device to be large in size and inconvenient for operating and carrying.

### CONTENTS OF THE INVENTION

In view of the forgoing, the main object of this invention is to provide an acupressure pen for applying a therapeutic amount of pressure to the skin and underlying tissue, which can deliver a precise and repeatable therapeutic pressure non-invasively, and should be compact in size for easy operating and carrying.

For achieving above object, this invention provides an acupuncture pen, which comprises: casing; a blunt tip, provided at the front end of the casing moveably; a sensing unit, provided in the casing for detecting the movement of the tip; an A/D converter, provided in the casing for converting the analog signal from the sensing unit into digital signal; a microcontroller, provided in the casing for receiving the digital signal from the A/D converter, and calculating the force blunt tip applied on the skin on the basis of the received digital signal; and a digital display, provided in the wall of the casing, and electrically connected with the microcontroller for indicating the calculated force.

The sensing unit further comprises: a spring, a pair of infrared sensor, and a reflective mirror. The spring is disposed between the tip and the casing and will be compressed by the force applied on said tip, that is to say, one end of the spring contact with the tip, and the other end of the spring is against the casing. The pair of infrared sensors, which is consisted of an IR transmitter and an IR receiver, disposed fixedly in the casing oppositely to the tip. The reflective mirror is connected to the tip, and can move along with the longitude direction of the acupuncture pen together with the tip. The distance between the pair of IR sensor and the reflective mirror will alter depending on the force applied on said tip. The light emitted from IR transmitter will be received by the IR receiver after being reflected by the reflective mirror, and the intensity of the received infrared light will increase as the distance becomes less. The IR receiver output voltage signal as the analog signal of the sensing unit, which indicates the distance between the pair of IR sensor and the reflective mirror, to the A/D converter.

The invention combines the ancient knowledge of traditional Chinese medicine with a sophisticated opto-mechatronic circuit, and makes use of a non-contact technique, i.e., infrared technique, to convert displacement data into a series of force signals. Therefore, it is convenient to use with the aid of the digital display of the applied force.

These and other features and advantages of the present invention will become more apparent from the detailed explanation of the embodiment of this invention with refer to the attached drawings.

### BRIEF DESCRIPTION OF THE DRAWINGS

FIG. 1 is a cross-section view of an acupuncture pen according to an embodiment of this invention;

FIG. 2 is a perspective view of the acupuncture pen;

FIG. 3 is a schematic drawing of the acupuncture pen of this invention; and

FIG. 4 is a schematic block diagram of the acupuncture pen of this invention.

### PREFERRED EMBODIMENTS OF THE INVENTION

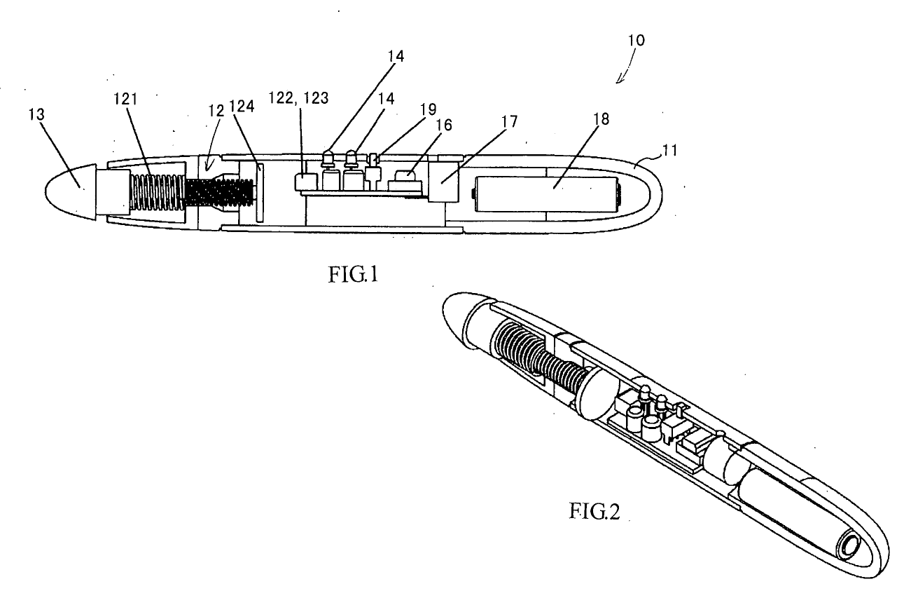

A preferred embodiment of the acupuncture pen of this invention is shown in FIGS. 1 and 2. FIG. 1 is a cross-section view of the acupuncture pen. FIG. 2 is a perspective view of the acupuncture pen. The acupuncture pen 10 of this invention comprises: a casing 11; a blunt tip 13, provided at the front end of the casing moveably; a sensing unit 12, provided in the casing 11 for detecting the movement of the tip 13; an A/D converter 15, provided in the casing 11 for converting the analog signal from the sensing unit 12 into digital signal; a microcontroller 16, provided in the casing 11 for receiving the digital signal from the A/D converter 15, and calculating the force that the blunt tip 13 applied on the skin on the basis of the received digital signal; and a digital display, provided in the wall of the casing, for indicating the calculated force.

Preferably, all the electrical component of this invention, such as A/D converter 15, microcontroller 16 and the digital display are mounted on a circuit board which is provided in the casing 11. The acupuncture pen of this invention may further comprise: a battery unit 18, provided in the rear portion of the casing 11, for providing power supply to the circuit board; and a buzzer 17, provided in the casing 11 and electrically connected to micro-controller 16. The buzzer 17 will beep if the pressure calculated by the microcontroller 16 exceeds a preset threshold.

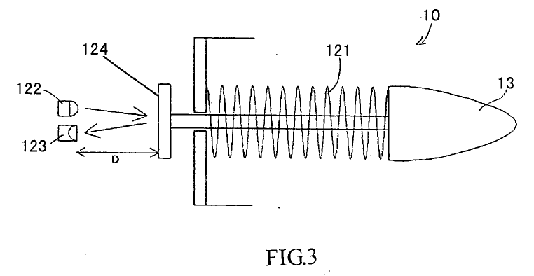

The sensing unit 12 of this invention makes use of non-contact infrared technique to detect the displacement of the tip 13, and further comprises: a spring 121, a pair of infrared sensor, and a reflective mirror 124. The spring 121 is disposed between the tip 13 and the casing 11. When the tip 13 is in contact with the skin of the human body, a force is applied by the tip 13 on the skin. On the other hand, the counter force is applied on the tip by the skin, and cause the spring 121 to be compressed. The pair of infrared sensors, which is consisted of an IR transmitter 122 and an IR receiver 123, disposed fixedly opposite to tip 13 in the casing. The reflective mirror 124 is connected to the tip 13 by a rod which passes through the center of the spring 121, and can move along with the longitude direction of the acupuncture pen together with the tip 13. As can be seen from FIG. 3, the distance D between the pair of IR sensor and the reflective mirror 124 can be altered depending on the force applied on the skin. The infrared light emitted from the IR transmitter 122 travels the distance D and be reflected by the reflective surface 124. The reflected infrared light travels the distance D again before being received by the IR receiver 123. The intensity of infrared light received by the IR receiver is stronger, if the distance D is shorter. Namely, the output voltage of the IR receiver 123 is higher as the distance D gets less. The relationship between the distance D and the output voltage of the IR receiver 123 is found linearly from a series of experiments. Therefore, the distance D can be determined by detecting the output voltage of the IR receiver 123.

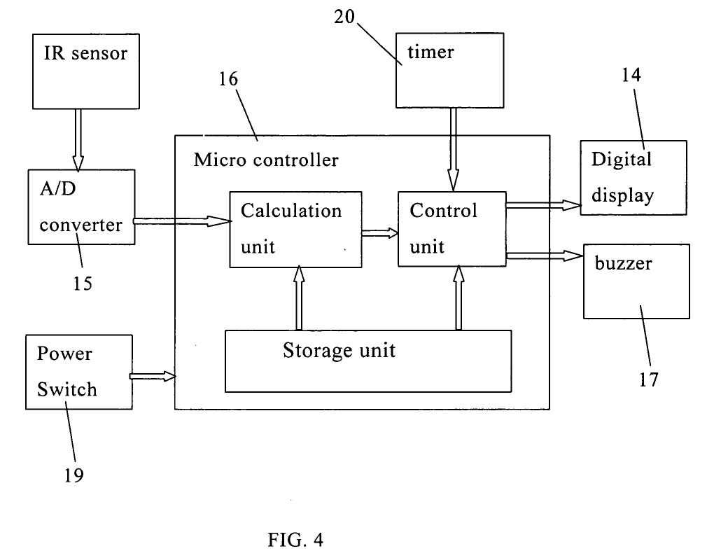

As can be seen in FIG. 4, which is the schematic block diagram of the acupuncture pen of this invention, the voltage signal of the IR receiver is sent to the A/D converter 15 as the form of analog signal, and is converted to digital signal in the A/D converter 15. The digital signal is then fed to the micro-controller 16. The micro-controller calculates the force applied on the skin based on the digital signal. At first, the displacement d of the tip 13 is determined by the equation: d=D′−D, in which the D′ is the initial distance between the pair of IR sensor and the reflective mirror 124 without applying any force on the tip 13; while the D is current distance after applying the force. Then the force can be obtained by applying a simple equation F=kd, in which, F denotes force applied to the head, k denotes spring constant, and d denotes the displacements of the tip 13. The calculated force will be displayed in the digital display 14.

Thus, the force applied on the skin can be controlled quantitatively by reading out the digital display.

The digital display 14 can be embodied as a LED, which will be lit when the force reaches a preset threshold, or as a more sophisticated LCD, which can display the digital value of the force in real time mode.

As shown in FIG. 4, the acupuncture pen of this invention may further comprise a timer 20 electrically connected with the micro-controller 16. When the applied pressure reaches the preset value, the micro-controller will activates the timer that measures the elapsed time period. When the elapsed time reaches the preset value, the buzzer 17 will beep to remind the user. By such configuration, users can control the duration and force intensity conveniently.

The microcontroller 16 further comprises: a storage unit, for storing the various preset parameters, such as the preset force value, preset elapsed time value, the spring constant k, initial distance D′ and so on; a calculation unit, connected with the storage unit, for calculating the force applied on the basis of the received digital signal with reference to the parameters stored in the storage unit; a control unit, for generating control signals for the digital display and the buzzer 17 on the basis of the calculated force and the elapsed time period inputted with reference to the parameters stored in the storage unit in a above-described manner.

In addition, a power switch 19 may be provided on the casing 11 for switching the acupuncture pen 10 on or off, as shown in FIGS. 1 and 4.

In practice, the acupuncture pen of this invention can be equipped with a series of acupuncture tips designed for various acupoints. The acupuncture pen of this invention can also come with a detailed instruction booklet that identifies the location of acupoints in the body for easy reference by the user.

Above explanation to this invention is only illustrative, rather than limitation to the scope of this invention. The acupuncture pen can be embodied in many configurations without departing the spirit of this invention. The scope of this invention will be defined by the claims appended below.

What is claimed is:

1. An acupuncture pen comprising:
a casing (11);
a blunt tip (13), provided at the front end of the casing moveably;
a sensing unit (12), provided in the casing (11) for detecting the movement of the tip (13);
an A/D converter (15), provided in the casing (11) for converting the analog signal from the sensing unit (12) into digital signal;
a microcontroller (16), provided in the casing (11) for receiving the digital signal from the A/D converter (15), and calculating the force applied by blunt tip (13) on the skin on the basis of the received digital signal; and
a digital display, provided in the wall of the casing, and electrically connected with the microcontroller (16) for indicating the calculated force.

2. The acupuncture pen as claimed in claim 1, the sensing unit (12) further comprises: a spring (121), a pair of infrared sensor, and a reflective mirror (124); said spring 121 is disposed between the tip (13) and the casing (11) and will be compressed by the force applied on said tip (13); the pair of infrared sensors, which is consisted of an IR transmitter (122) and an IR receiver (123), disposed fixedly opposite to tip (13) in the casing; the reflective mirror (124) is connected to the tip (13), and can move along with the longitude direction of the acupuncture pen together with the tip (13); the distance between the pair of IR sensor and the reflective mirror (124) will alter depending on the force applied on said tip; the light emitted from IR transmitter (122) will be received by the IR receiver (123) after being reflected by the reflective mirror (124); the IR receiver (123) output a voltage signal as said analog signal, which is in proportion to the distance, to the A/D converter (15).

3. The acupuncture pen as claimed in claim 1, said A/D converter (15), microcontroller (16) and the digital display are mounted on a circuit board provided in the casing (11).

4. The acupuncture pen as claimed in claim 3, further comprising a battery unit (18), provided in the rear portion of the casing (11), for providing power supply to the circuit board.

5. The acupuncture pen as claimed in claim 1, the digital display is a LED, which will light when the calculated force reaches a preset threshold.

6. The acupuncture pen as claimed in claim 1, the digital display is a LCD, which can display the digital value of the calculated force in real time mode.

7. The acupuncture pen as claimed in claim 1, further comprising a timer (20) electrically connected with the micro-controller (16) for measuring the elapsed time period after the calculated force reaches a preset threshold.

8. The acupuncture pen as claimed in claim 7, further comprising a buzzer (17), provided in the casing (11) and electrically connected to micro-controller (16); the buzzer (17) will beep if the calculated force reaches a preset threshold and/or the elapsed time period reaches a preset value.

9. The acupuncture pen as claimed in claim 8, the microcontroller (16) further comprises:
a storage unit, for storing the various preset parameters;
a calculation unit, connected with the storage unit, for calculating the force applied on the basis of the received digital signal with reference to the parameters stored in the storage unit;
a control unit, for generating control signals for the digital display and the buzzer (17) on the basis of the calculated force and the elapsed time period inputted with reference to the parameters stored in the storage unit.

10. The acupuncture pen as claimed in claim 1, further comprises a power switch (19), for switching the acupuncture pen on or off.
